(19) United States
(12) Patent Application Publication
(10) Pub. No.: US 2025/0328784 A1
(43) Pub. Date: Oct. 23, 2025

(54) AUTOMATIC SYSTEM FOR NEW EVENT IDENTIFICATION USING LARGE LANGUAGE MODELS

(71) Applicant: Microsoft Technology Licensing, LLC, Redmond, WA (US)

(72) Inventor: Alison Ruth CAULFIELD, Seattle, WA (US)

(73) Assignee: Microsoft Technology Licensing, LLC, Redmond, WA (US)

(21) Appl. No.: 18/637,763

(22) Filed: Apr. 17, 2024

(51) Int. Cl. G06N 5/025; G06F 18/2415

(52) U.S. Cl. CPC G06N 5/025; G06F 18/2415

(57) ABSTRACT

Examples of the present disclosure describe systems and methods for automating the identification of events in a text file. In examples, a computing system identifies a subset of a text file that comprises an unknown event using a set of rules. Each rule of the set of rules specifying a first pattern of characters is compared to the subset of the first text file. When the set of rules does not identify the unknown event, the subset of the text file is provided to a language model to generate a new rule with a second pattern of characters and an identifier of the new rule. The system then generates an updated set of rules by adding the new rule to the set of rules.

### BACKGROUND

Traditionally, text-based event recording systems are analyzed using a rule-based framework to match portions of text to identify and handle recorded events. This process limits the number of events identified in the text-based event recording system to the statically defined rules in the rule-based framework. Any new event not previously imagined as part of the rules in the rule-based framework requires a manual review of the text associated with the new event to generate a rule. Other modern text-based event recording systems may use language models to avoid being limited by static rules when identifying various events recorded in text. Identifying events using a machine learning language model is an expensive operation. Further, machine learning language models are limited by the size of the input provided to the machine learning language models. In a continuous event recording text-based system, the overall text size may exceed the input size permitted by the machine learning language model.

It is with respect to these and other general considerations that the aspects disclosed herein have been made. Also, although relatively specific problems may be described, it should be understood that the examples should not be limited to solving the specific problems identified in the background or elsewhere in this disclosure.

### SUMMARY

Examples of the present disclosure describe systems and methods for performing automation identification of an event. According to one or more embodiments of the present disclosure, a system for automatic new event identification includes a processor and a memory coupled to the processor, consisting of computer executable instructions executed by the system to perform operations. The operations include identifying a subset of a received text file that includes an unknown event and identifying the unknown event by comparing the subset to a set of rules. The set of rules includes a pattern of characters that can identify a known event. The system analyzes each subset of text in the received text file by comparing a pattern of characters in each rule from a set of rules to each subset of the text file. When the system identifies a subset of the text file that does not match any of the set of rules, it provides the subset of text to a language model to determine a new rule to identify the unknown event. The language model provides a new pattern of characters that matches the subset of a text file and identifies the unknown event. The system uses the new pattern of characters to generate a new rule and include the new rule in the set of rules. When the system receives a subset of another text file including the unknown event, the system can identify the unknown event in a subset of another text file by matching the new rule to the subset of the other text file.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following Figures.

FIG. 1 illustrates a block diagram of an example text-based system for automated event type identification.

FIG. 2 is a flow diagram of the interaction between components of an exemplary text-based system to analyze text files.

FIG. 3 is a flow diagram of the transformation of an unknown event to a rule used by the text-based system of FIG. 1 to identify events.

FIG. 4 is an exemplary few-shot example provided as input to a language model of the text-based system of FIG. 1.

FIG. 5 depicts an example method for automatically identifying events in text files using rules.

FIG. 6 depicts an example method for identifying a subset of a text file indicative of an event.

FIG. 7 depicts an example method for processing a subset of a text file before providing the subset of a text file to a language model to identify an unknown event in the subset of a text file.

FIG. 8 is a block diagram illustrating an example of the physical components of a computing device for practicing aspects of the disclosure.

### DETAILED DESCRIPTION

The disclosed system utilizes a combination of different functions to identify the event types in input data using outputs and evolves to generate new outputs to help identify new event and/or event types. The system balances input resources, efficiency, and expandability when using different functions to identify event types.

In one implementation, the disclosed system uses an efficient (e.g., computationally efficient in terms of speed and cost) but limited (e.g., preset number) rule-based function to identify events and event types in input data and perform activities to generate output. The disclosed system uses an Artificial Intelligence (AI) model, such as a large language model (LLM), to generate a new rule when the rule-based function fails to include a rule to identify a new event of a new event type. When the system generates a new rule to include in the rule-based function, the rule-based function can identify an event of the new event type in input data in the future. Using the rule-based function in combination with the AI model allows continuous expansion of capabilities of the rule-based function. It is contemplated that the disclosed system may have multiple practical use cases using a text-based framework to receive input data in a text source (e.g., a data file, data stream, a data broadcast, or a chat dialog data) (hereinafter referred to as a “text file”). It is also contemplated that the disclosed systems may process non-text format input data, for example, image, audio, and video.

For example, an event log system recording the occurrence of various events can identify the recorded events by parsing the log file using rules, such as regular expressions. When the regular expressions cannot identify a new event, such as a new or previously undefined error, an AI model is employed to identify the new event and to generate the regular expression to identify the newly identified event in the future.

In another example, in a chatbot system linked to an activity, such as an application programming interface (API) call, chat text received by the chatbot system is parsed to identify whether the chat text causes any API calls to perform. The rule-based function may identify keywords in the chat text to determine the type of API call to perform or to trigger internal code execution within the chatbot. To support the rule-based function, the chatbot can be supplemented by an AI model that parses chat text, which includes unknown keywords, to identify the unknown keywords and determine the type of API calls to perform based on the unknown keywords. The unknown keywords are not included in the rule-based function and may represent synonyms or variations of known keywords. For example, the rule-based function identifies the keyword “help” in the chat text “requesting help” but fails to identify a keyword variation “helper” in the chat text “requesting helper.” In another example, the rule-based function identifies the keyword “help” in the chat text “requesting help” but fails to identify a synonymous keyword “aid” in the chat text “requesting aid.” To facilitate future identification of unknown keywords, the chatbot system can add the unknown keywords to the rule-based function.

In yet another example, a bot system, such as a code review bot, receives input text in the form of pull requests. A pull request refers to a request to merge a first version of software code to a second version of software code. As one example, a pull request may indicate an intent to merge software code from a feature branch of a codebase to a repository comprising the main branch of the main codebase. The bot system uses the rule-based function to analyze changes in the pull requests and automatically insert comments into the analyzed pull requests to enforce coding practices and conventions. In the event that changes in the pull requests are not identifiable using the rule-based function (e.g., due to the rule-based function not including rules for identifying the changes), the AI model is used to identify, define, and create a rule for inserting comments into the pull requests based on the changes, and updating the bot for future capability.

In another example of a non-text input file scenario, an example system that recognizes objects in an image based on certain rules describing patterns of pixels may fail to identify a new object or an object that is shaped differently than others. For example, a rule to recognize victorian style homes in images may not recognize other styles, such as edwardian style homes. An AI model trained to recognize different homes can be incorporated to identify the pattern of pixels for edwardian style homes and create a rule for the system to recognize the edwardian style homes.

The interplay between a rule-based function used to efficiently identify and handle types of input activity and an AI model used to determine/define new rules for new types of input activity and categorize unknown input into existing rules ensures the individual limitations of both the rule-based function and the AI model are overcome.

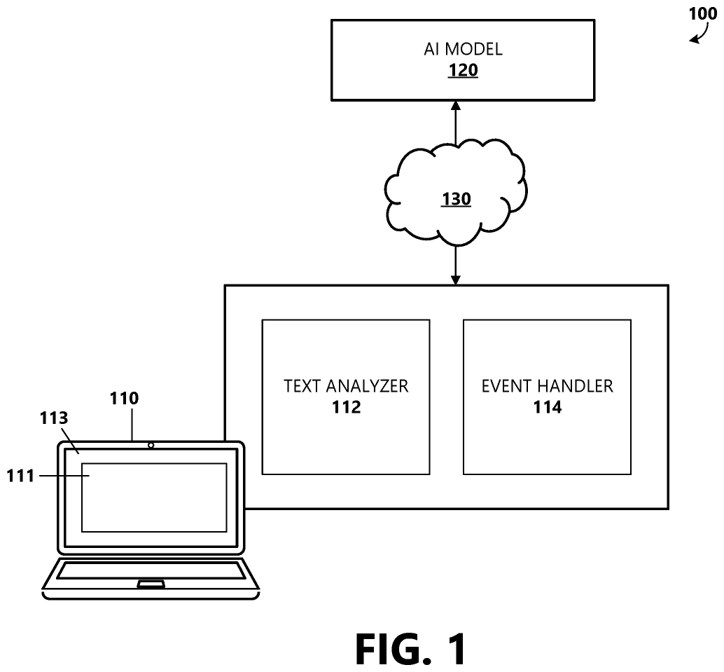

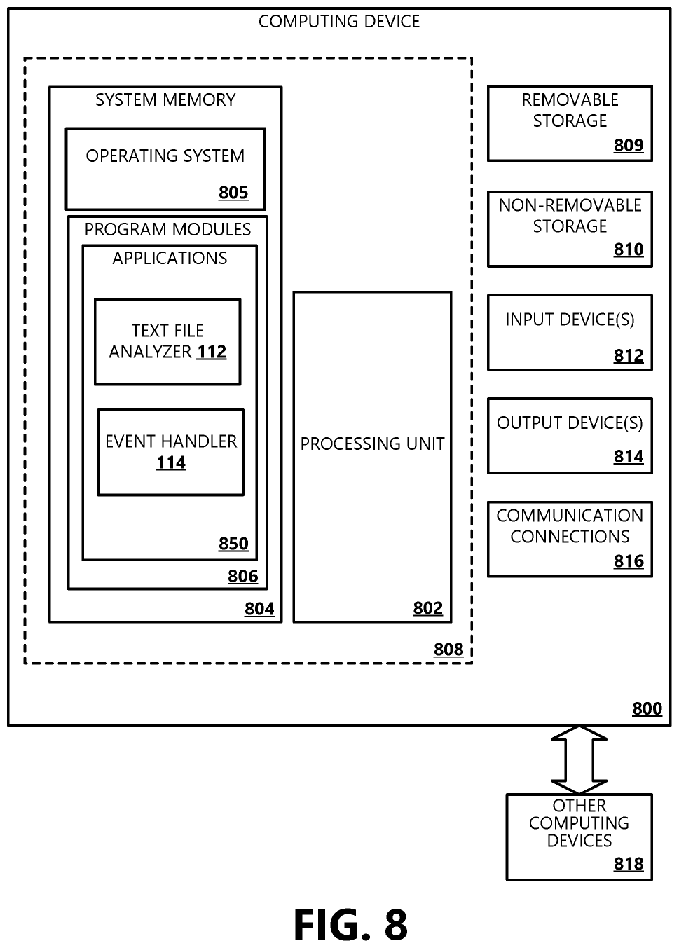

FIG. 1 illustrates a block diagram of an example text-based system for automated event type identification. The system 100, as depicted, is a combination of interdependent components that interact to form an integrated whole. Some components of system 100 are illustrative of software applications, systems, or modules that operate on a computing system or across a plurality of computing systems. Any suitable computer system(s) may be used, including web servers, application servers, network appliances, dedicated computer hardware devices, virtual server devices, personal computers, a system-on-a-chip (SOC), or any combination of these and/or other computing devices known in the art. In one example, components of systems disclosed herein are implemented on a single processing device. The processing device may provide an operating environment for software components to execute and use resources or facilities of such a system. An example of processing device(s) comprising such an operating environment is depicted in FIG. 8. In another example, the components of systems disclosed herein are distributed across multiple processing devices.

In FIG. 1, system 100 comprises computing device 110, application user interfaces (UIs) 111, text analyzer 112, display screen 113, event handler 114, AI model 120, and network 130. Although system 100 is depicted as comprising a particular combination of computing devices and components, the scale and structure of devices and components described herein may vary and may include additional or fewer components than those described in FIG. 1. For instance, AI model 120 may be implemented by computing device 110 and/or one or more of text analyzer 112 or event handler 114 may be implemented remotely from computing device 110. Further, although examples in FIG. 1 and subsequent figures will be described in the context of event type identification (e.g., software installation errors) and handling events (e.g., identifying bugs), the examples are equally applicable to other contexts. For instance, one or more examples are also applicable to other scenarios of identifying input text type and performing activities, such as calling an API.

According to example implementations, computing device 110 may take a variety of forms, including, for example, desktop computers, laptops, tablets, smartphones, wearable devices, gaming devices/platforms, virtualized reality devices/platforms (e.g., virtual reality (VR), augmented reality (AR), mixed reality (MR)), etc. The computing device 110 has an operating system that provides a graphical user interface (GUI), such as UIs 111, that allows users to interact with the computing device 110 via graphical elements, such as application windows (e.g., display areas), buttons, icons, and the like. For example, the graphical elements are displayed on a display screen 113 of the computing device 110. The graphical elements can be selected and manipulated via user inputs received via a variety of input device types (e.g., keyboard, mouse, stylus, touch, spoken commands, gesture).

Computing device 110 includes a text analyzer 112 that analyzes input data stored in documents, such as software installation and upgrade log files, application access log files, network log files, etc. In one implementation, the text analyzer 112 allows users to provide log files, identify unexpected events (e.g., installation failure, unauthorized access, security breaches, network congestion, or anomalous activity) among various events recorded in the log files, and identify software bugs associated with unexpected events. In another implementation, text analyzer 112 analyzes live input data, such as text in a chat dialog to identify events (e.g., activity requests in a chat dialog) and perform the identified events.

Text analyzer 112 may be a local application/service, a web-based application/service accessed via a web browser, or a combination thereof (e.g., some operations may be performed locally, and other operations may be performed at a web server). Text analyzer 112 may run as a background process or may be explicitly invoked on-demand. Text analyzer 112 may have access to one or more application UIs 111 by which a user can provide requests related to a text file (e.g., a request to parse text files). For example, an application UI 111 is presented on display screen 113 to receive a path to a text file, streaming content from a text file, or a request to parse a text file at a location known to text analyzer 112. In some examples, the operating environment is a multi-application environment by which a user may view and interact with text analyzer 112 through multiple application UIs 111.

In an example implementation, text analyzer 112 determines a subset of text (e.g., one or more words, lines, sentences, paragraphs, or sections) that includes content relevant to an unknown event and retrieves relevant examples of other known events from a repository (not illustrated) storing known events. Unknown events include events that have not been previously detected and/or identified among events recorded in input data analyzed by text analyzer 112. The determined subset of text and/or the retrieved relevant examples are included in input (e.g., a prompt or other instructions) provided to AI model 120 to identify the unknown event and/or event type.

Event handler 114 receives details that identify an unknown event from AI model 120 and stores the details of the unknown event as an identified event. Upon later detecting a new instance the identified event in the future, text analyzer 112 transmits stored details of the identified event to the event handler 114. Event handler 114 determines the steps to handle an event based on the event type associated with the event. For example, event handler 114 may be a bug filing system that identifies software bugs upon the occurrence of an unexpected event representing a software failure. In another example, event handler 114 may instantiate additional compute resources (e.g., memory, processing power, storage, networking) based on an event type of an unexpected event representing compute resources availability levels. In some examples, event handler 114 determines the steps to handle an event based on the identity of the event. For example, event handler 114 makes an API call to a service based on the identity (e.g., the name or other identifier) of the service being included in the event. In some examples, event handler 114 is part of text analyzer 112 or vice versa.

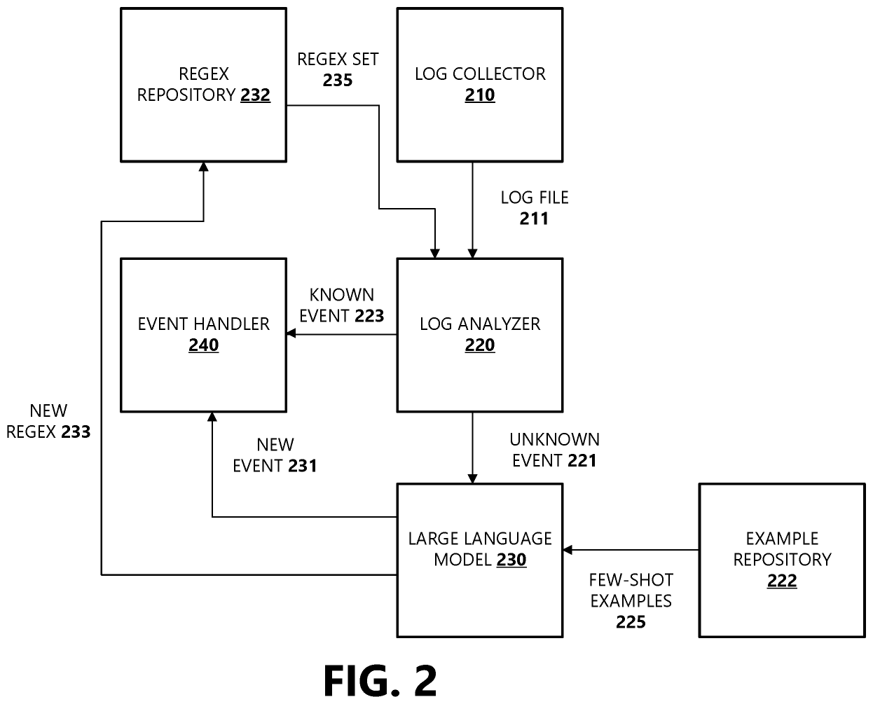

AI model 120 receives input associated with a subset of text from text analyzer 112. In response to the input, AI model 120 generates an output payload. The output payload may include details identifying an unexpected event and rules that can be used to detect and identify the unexpected event in the future. For instance, the output payload may include one or more regular expressions that can be used to enable text analyzer 112 to identify previously unknown events in the future. These and other examples are described below in further detail with reference to FIGS. 2-7.

AI model 120 may be an LLM, a multimodal model, or other types of generative AI models. Example of AI model 120 include the Generative Pre-trained Transformer (GPT) models from OpenAI, Bard from Google, and/or Large Language Model Meta AI (LLaMA) from Meta. In some examples, AI model 120 is a deep neural network that utilizes a transformer architecture to process a prompt, such as text, that it receives as an input or query. The neural network may include an input, multiple hidden, and output layers. The hidden layers typically include attention mechanisms that allow AI model 120 to focus on specific parts of the input text and generate context-aware outputs. AI model 120 is generally trained using supervised learning based on large amounts of annotated text data and learns to provide a response synthesizing relevant content.

The size of AI model 120 may be measured by its number of parameters. For instance, as one example of an LLM, the GPT-4 model from OpenAI has billions of parameters. These parameters may be weights in the neural network that define its behavior, and a large number of parameters allow the model to capture complex patterns in the training data. The training process typically involves updating these weights using gradient descent algorithms and is computationally intensive, requiring large amounts of computational resources and a considerable amount of time. However, AI model 120 in the examples herein is pre-trained (e.g., has already been trained) using a large amount of data. This pre-training allows the model to understand the structure and meaning of the text, making it more effective for the specific tasks discussed herein.

AI model 120 may operate as a transformer-type neural network. Such an architecture may employ an encoder-decoder structure and self-attention mechanisms to process input (e.g., the prompt or instructions). Initial processing of the input may include tokenizing the input into tokens that may then be mapped to a unique integer or mathematical representation. The integers or mathematical representations are combined into vectors that may have a fixed size. These vectors may also be known as embeddings.

The initial layer of the transformer model receives the token embeddings. Each of the subsequent layers in the model may use a self-attention mechanism that allows the model to weigh the importance of each token in relation to every other token in the input. In other words, the self-attention mechanism may compute a score for each token pair, which signifies how much attention should be given to other tokens when encoding a particular token. These scores are then used to create a weighted combination of the input embeddings.

In some examples, each layer of the transformer model comprises two primary sub-layers: the self-attention sub-layer and a feed-forward neural network sub-layer. The above-mentioned self-attention mechanism is applied first, followed by the feed-forward neural network. The feed-forward neural network may be the same for each position, and a simple neural network may be applied to each attention output vector. The output of one layer becomes the input of the next. This means that each layer incrementally builds upon the understanding and processing of the data made by the previous layers. The output of the final layer may be processed and passed through a linear layer and a SoftMax activation function. This outputs a probability distribution over all possible tokens in the model's vocabulary. The token(s) with the highest probability is selected as the output token(s) for the corresponding input token(s).

In example implementations, AI model 120 operates on a device located remotely from the computing device 110. For instance, the computing device 110 may communicate with AI model 120 using one or a combination of networks 130 (e.g., a private area network (PAN), a local area network (LAN), and a wide area network (WAN)). In some examples, AI model 120 is implemented in a cloud-based environment or server-based environment using one or more cloud resources, such as server devices (e.g., web servers, file servers, application servers, database servers), personal computers (PCs), virtual devices, and mobile devices. The hardware of the cloud resources may be distributed across disparate regions in different geographic locations.

FIG. 2 is a flow diagram of the interaction between components of an example text-based system used to analyze text files. Log collector 210 begins the process of detecting and identifying events in log file 211 (e.g., a text file including a log of events), and transmitting log file 211 to log analyzer 220. Log collector 210 maintains a record of the occurrence of any event in log file 211. Log collector 210 may transmit log file 211 upon the occurrence of a triggering event, such as the expiration of a timer or the detection of an event. For instance, log collector 210 transmits log file 211 upon detecting a failure to install, upgrade, or execute software on one or more devices. Alternatively, log collector 210 transmits log file 211 at regular intervals (e.g., hourly or daily). In some examples, log file 211 is a pointer to one or more segments of data located within a data stream. In other examples, log file 211 is at least a portion of a data file. Log collector 210 maintains an ongoing list of entries that each identify a portion of log file 211 transmitted to log analyzer 200 and a pointer to the oldest entry (e.g., memory address or index number in the list of the entries) that has not yet been provided to log analyzer 220. Log collector 210 moves the pointer to an entry that needs to be processed next by log analyzer 220. Log collector 210 may add new entries to the bottom of log file 211.

Log analyzer 220 reviews log file 211 for events and identifies the events using a set of rules, such as regular expression (regex) set 235. Rules may be represented as information stored in a table mapping events to an identifier, including a name and a description of the rule. In some examples, rules are represented as or cause the execution of a program to perform an activity, such as filing a bug report or making an API call to a separate service, application, or system. In other examples, rules may be represented as regular expressions (e.g., regex set 235) configured to identify specific patterns of text in log file 211 (e.g., via matching text in the log file 211 to predetermined character patterns) in order to identify an event. Log analyzer 220 may maintain a list of known events that are events identifiable using rules, such as known event 223, and a separate list of unknown events that are events not identifiable using the rules, such as unknown event 221. In examples, upon identifying known event 223, log analyzer 220 transmits the known event 223 to event handler 240. However, upon identifying unknown event 221, log analyzer 220 provides the unknown event 221 and/or at least a portion of log file 211 as input to LLM 230.

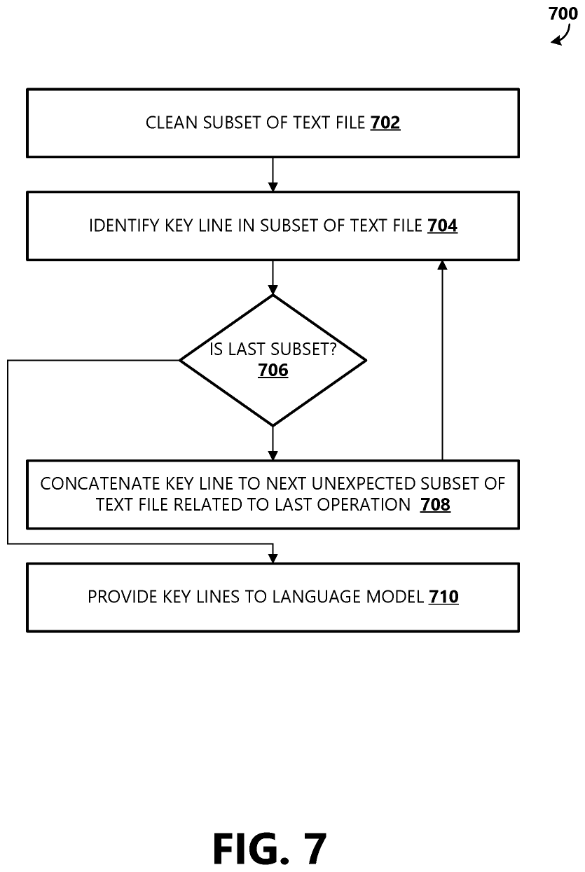

Unknown event 221 may include a subset of text from log file 211. For instance, unknown event 221 may include one or more lines of text indicating the occurrence of an error during the execution of software code. The lines of text may be accompanied by a number of additional lines preceding and/or following the lines of text. The additional lines may provide additional context for the lines of text indicating the occurrence of the error. The subset of text of log file 211 may also include details of unknown events in log file 211, including lines of text of log file 211 to identify events and an error code. Log analyzer 220 determines the lines of text in log file 211 with relevant information related to unknown event 221. In some examples, LLM 230 identifies the key lines of text in log file 211 with relevant information related to unknown event 221. The key lines of text in log file 211 with relevant information are those lines that can be used to diagnose and uniquely reidentify an event in the future. Lines with relevant information provide information on an event that is specific and detailed enough to identify the event and identify ways to address the event. In some examples, a single line in log file 211 is enough to reidentify an event. In other examples, multiple lines are needed to reidentify an event. In some examples, log analyzer 220 provides multiple subsets of text from log file 211 to identify multiple key lines of text in log file 211 used to identify an unknown event encountered by log analyzer 220 when reviewing log file 211. A detailed description of steps to identify key lines associated with an unknown event is provided in FIG. 7 description below.

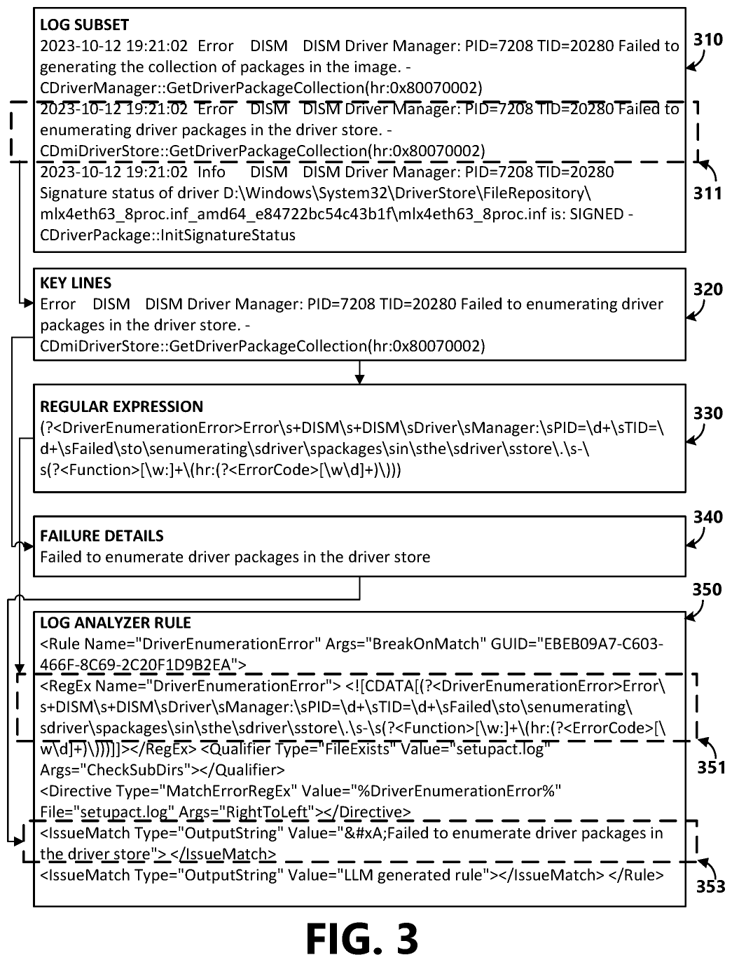

LLM 230 receives unknown event 221 from log analyzer 220. In examples, LLM 230 is an implementation of AI model 120 (as shown in FIG. 1). LLM 230 generates new event 231 and new regex 233 based on unknown event 221. New event 231 includes the identity of unknown event 221 to provide to event handler 240 to perform specific event handling steps. Log analyzer 220 accesses the new event 231 to identify future occurrences of unknown event 221. New regex 233 may include a regular expression forming a rule used by log analyzer 220 to identify new event 231. Log analyzer 220 may use new event 231 and new regex 233 to identify unknown event 221 in the future without invoking LLM 230. The generation of regular expressions and rules to identify an event in a subset of text in the log file 211 using an LLM (e.g., LLM 230) is described in detail in FIG. 3 description below.

LLM 230 may be called multiple times by log analyzer 220 to identify unknown event 221. For example, log analyzer 220 may first call LLM 230 to identify key lines related to unknown event 221 in log file 211. Log analyzer 220 may then call LLM 230 again to determine the identity of unknown event 221 and generate a regular expression that enables log analyzer 220 to identify unknown event 221 in the future (e.g., without using LLM 230). In some examples, log analyzer 220 invokes LLM 230 once to new event 231 and associated new regex 233.

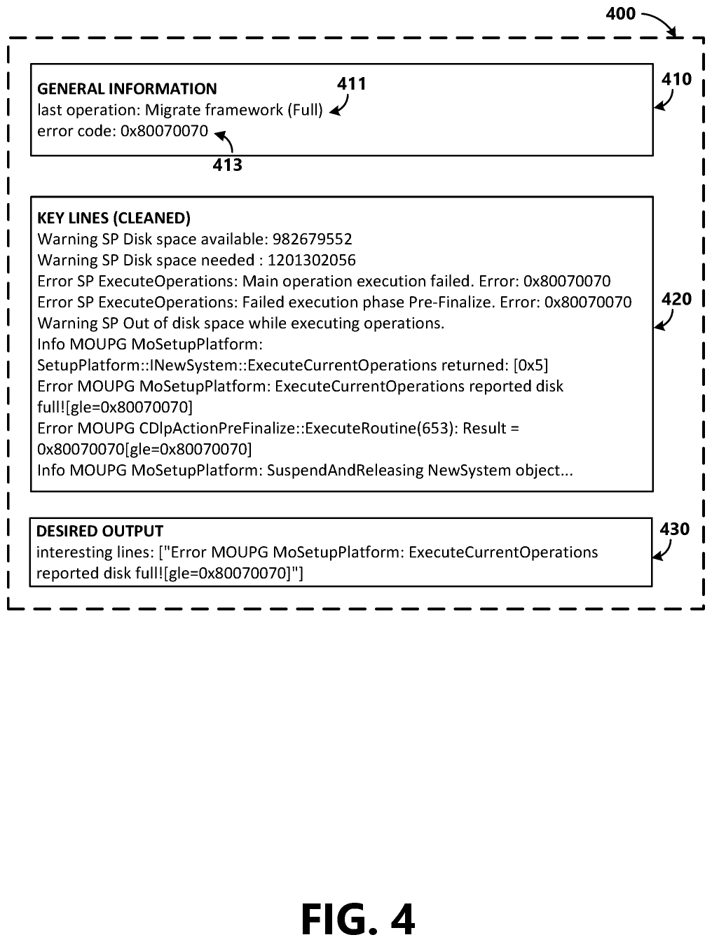

In some examples, the input provided to LLM 230 (e.g., unknown event 221 and/or additional information accompanying unknown event 221) includes example known events (e.g., few-shot examples 225). The example known events are used to determine key lines of text in log file 211 that can be used to identify unknown event 221 and to generate a regular expression matching the key lines of text. In some examples, log analyzer 220 generates an input to LLM 230 by combining key lines of log file 211 with few-shot examples 225. A few-shot example is described in the description of FIG. 4 below.

Example repository 222 includes various example events described using key lines of text from previously reviewed log files and/or log files comprising predefined known event examples. Example repository 222 provides few-shot examples 225 as input to LLM 230. In some examples, log analyzer 220 retrieves (not illustrated) few-shot examples 225 from the example repository 222 to generate an input for LLM 230.

Upon identifying new event 231, LLM 230 may transmit the new event 231 to event handler 240. In some examples, LLM 230 transmits (not illustrated) the identified new event 231 back to log analyzer 220 to determine whether to store new event 231 as an example event in the example repository 222. LLM 230 may additionally transmit (not illustrated) new event 231 to example repository 222 to be stored as an example event. In examples, upon identifying new event 231, LLM 230 generates a new rule (e.g., new regex 233) to identify the content of unknown event 221 in the future (e.g., without using LLM 230). For instance, if a subsequent log file 211 comprising the content of unknown event 221 is provided to log analyzer 220 in the future, log analyzer 220 will be able to identify the event as a known event based on the new regex 233. In some examples, LLM 230 generates the new regex 233 based on content (e.g., example regular expressions) in the input provide to LLM 230. LLM 230 transmits new regex 233 to regex store 232, which stores new regex 233 for future use in identifying the content of unknown event 221. In at least one example, LLM 230 also transmits new event 231 and/or a mapping of new regex 233 to new event 231 to regex repository 232. Log analyzer 220 may use the mapping between new regex 233 and new event 231 to identify an event in the log file 211 and to provide the event to event handler 240.

Event handler 240 receives details of an event, such as known event 223 and new event 231, from log analyzer 220 and LLM 230. Event handler 240 identifies software issues (e.g., software bugs or other software anomalies) for the known event 223 and new event 231. The software issues may correspond to software failures, hardware failures, or the degradation of software and/or hardware performance. In examples, event handler 240 is an implementation of event handler 114 (as shown in FIG. 1).

FIG. 3 is a flow diagram of the transformation of an unknown event to a rule used by the text-based system of FIG. 1 to identify events. As illustrated in FIG. 3, log subset 310 is used to determine key lines 320 of an event and to generate log analyzer rule 350 to identify the event in the future. Log analyzer 220 (as shown in FIG. 2) may extract log subset 310 from log file 211 (as shown in FIG. 2) and request LLM 230 (as shown in FIG. 2) to identify key lines 320 in log subset 310. LLM 230 may determine key lines 320 that aid in identifying an event, such as an error during software installation. In some examples, log analyzer 220 may process log subset 310 before providing log subset 310 to LLM 230. For instance, certain information (e.g., time stamps or log entry sequence values) may be removed from line 311 in log subset 310 before log subset 310 is provided to LLM 230. Alternatively, upon receiving log subset 310, LLM 230 may process log subset 310 as part of identifying key lines 320.

Key lines 320 include lines of text with the relevant information related to an event, i.e., driver error, in a log subset 310. Lines of text that include relevant information are those lines that can be used to diagnose and uniquely reidentify the reoccurrence of an event in the future. The information about an event provided by key lines 320 is specific and includes detail to uniquely identify and process an event. For example, key lines 320 in log file 320 include the exit code associated with the software failure. As shown in FIG. 3, key lines 320 include the exit code “0x80070002” and include details such as “failed to perform action” or “the driver failed.” LLM 230 may use key lines 320 to generate a regular expression 330 to identify the event (e.g., a failure to enumerate driver packages) in future log subsets. In examples, log analyzer 220 uses regular expression 330 to identify future occurrences of the event without providing a request to identify key lines of the future occurrences to the LLM 230. Key lines 320 may also be used to determine failure details 340, which indicates the identity of the error in log subset 310. Failure details 340 may include a human-readable explanation of the event (e.g., error) extracted automatically by LLM 230. In some examples, a user of system 100 (as shown in FIG. 1) may use UI 111 to revise the text extracted from key lines 30 to generate failure details 340. For example, LLM 230 extracts the human-readable text “Failed to enumerating driver packages in the driver store” from key lines 320 and a user revises the text to “Failed to enumerate driver packages in the driver store” to include in failure details 340. LLM 230 may identify machine codes such as “TID=20280” and extract text afterward to include in failure details 340.

Log analyzer rule 350 is used to identify events in a log file. Log analyzer 220 may use regular expression 330 and failure details 340 to generate log analyzer rule 350. Log analyzer rule 350 includes regular expression 330 and failure details 340 as regex 351 and output 353, respectively. Log analyzer rule 350 is formatted based on the type of log analyzer used to parse logs and identify events, or the format of log analyzer rule 350 can be agnostic to the type of log analyzer.

FIG. 4 is an exemplary few-shot example provided as input to a language model of the text-based system of FIG. 1. As illustrated in FIG. 4, few-shot example 400 includes portions 410-430 that are used in identifying an unknown event (e.g., unknown event 221 of FIG. 2) encountered in a text file (e.g., log file 211 of FIG. 2). Few-shot example 400 defines an event representing a disk full error. Few-shot example 400 includes general information 410, which lists last operation 411 and error code 413 that resulted in the event. Few-shot example 400 also includes key lines 420, which uniquely represents the event of disk full error along with the error code. LLM 230 determines the uniqueness of a line in a log file (e.g., log file 211 of FIG. 2) by checking if a regular expression can uniquely match the line in the log file. LLM 230 may process a line by removing text to make a line a unique match for a regular expression. Further, few-shot example 400 includes output 430, which represents the desired output presented when a text file analyzer (e.g., log analyzer 220 of FIG. 2) detects and identifies the error associated with key lines 420.

Having described a system that may be employed by the aspects disclosed herein, this disclosure will now describe methods that may be performed by various aspects of the disclosure. In aspects, methods 500-700 may be executed by a system, such as system 100 of FIG. 1. However, methods 500-700 are not limited to such examples.

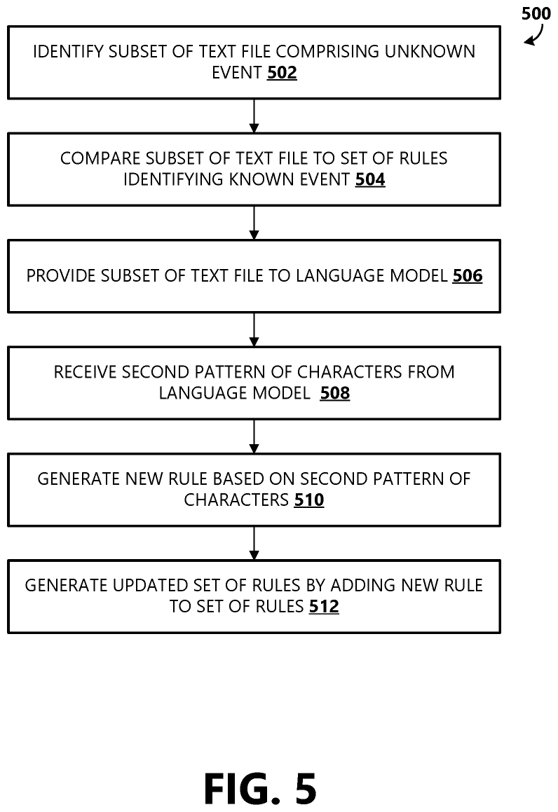

FIG. 5 depicts an example method for automatically identifying events in text files using rules. At operation 502, a subset (e.g., log subset 310 of FIG. 3) of a text file (e.g., log file 211 of FIG. 2) is identified from a text file (e.g., log file 211 of FIG. 2). The subset of a text file may include an unknown event (e.g., unknown event 221 of FIG. 2). An unknown event may be a user request or a result of a user request. For example, a user in communication with a chatbot may request in a chat text access to a function, such as launching an application or making an API call. In another example, a user's request to install software may result in logging the event of success or failure in a log file. In another example, an access request for a service may result in logging events (e.g., events indicative of security, network, or resource issues) in access logs and network logs.

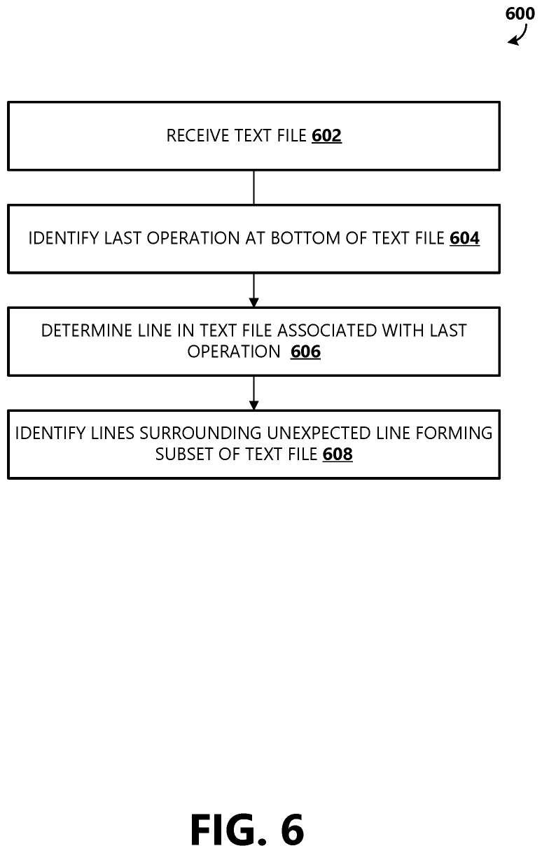

A subset of a text file may be identified before comparing a set of rules in operation 504 below. A subset of a text file may be identified based on the lines of text in the received text file that can provide information about an unknown event. A detailed description of identifying a subset of a text file is presented in the FIG. 6 description below. In some examples, multiple subsets of a text file associated with an unknown event may be identified before comparing to a set of rules that matches an unknown event. In some examples, different rules of the set of rules are applied to different subsets of a text file.

At operation 504, the subset of a text file identified in operation 502 is compared to a set of rules (e.g., regex set 235 of FIG. 2). The set of rules is used to identify a known event (e.g., known event 223 of FIG. 2) in the subset of a text file. A rule in a set of rules is applied to the subset of a text file to identify content in the subset of the text file that matches the rule. A rule can include program logic for a keyword match applied to text strings in a text file to find a match. For example, a rule specifies a pattern of alphanumeric characters (hereinafter referred to as “characters”), such as a regular expression (e.g., regular expression 330 of FIG. 3) that matches lines of text indicative of a known event. In another example, the input can be a non-text file such as an image, audio, or video file and a rule can be based on a pattern of objects, such as pixels forming an example sketch of an object to find a match.

At operation 506, the subset of a text file identified in operation 502 is provided to a language model (e.g., LLM 230 of FIG. 2). The subset of a text file may be provided to a language model over a network (e.g., network 130 of FIG. 1) to identify an unknown event. The subset of a text file is provided to a language model for identifying an event when none of the set of rules can identify an unknown event in the subset of a text file. In some examples, the subset of a text file is processed to identify and provide key lines (e.g., key lines 420 of FIG. 2) to a language model. A detailed description of processing the subset of a text file before providing the subset of a text file to a language model is described in FIG. 7 description below.

In some examples, few-shot examples (e.g., few-shot examples 225 of FIG. 2) from an example repository (e.g., example repository 222 of FIG. 2) are provided as input to a language model along with the subset of a text file. The few-shot examples may be selected dynamically based on the subset of a text file. Keywords in the subset of a text file representing an unknown event may be used to select the few-shot examples dynamically. For example, the keywords representing an unknown event define the type of event, such as a storage error, and are used to select other few-shot examples that represent the same type of error.

At operation 508, a second pattern of characters (e.g., new regex 231 of FIG. 2, regular expression 330 of FIG. 3) is received from a language model upon requesting to identify an unknown event in the subset of a text file. The second pattern of characters may be received over a network.

At operation 510, a new rule (e.g., log analyzer rule 350 of FIG. 3) is generated based on second pattern of characters received from the language model. A new rule is generated by including the second pattern of characters in the new rule. For example, as illustrated in FIG. 3, regular expression 330 with a set of characters is inserted into log analyzer rule 350 as regex 351.

In some examples, details associated with the unknown event are determined as part of generating the new rule. The details may include a human-readable explanation of the unknown event. The details may be extracted from the subset of a text file provided to a language model and included in the new rule along with the second pattern of characters. For example, failure details 340 (as shown in FIG. 3) of an unknown event represented in line 311 (as shown in FIG. 3) is extracted from log subset 10 (as shown in FIG. 3) and included as output 353 (as shown in FIG. 3) in log analyzer rule 350 (as shown in FIG. 3).

At operation 512, the new rule (e.g., new regex 233 of FIG. 2, log analyzer rule 350 of FIG. 3) generated in operation 512 is added to the set of rules (e.g., regex repository 232 of FIG. 2) to generate an updated set of rules. The updated set of rules is stored in the storage location of the previously stored set of rules. The updated set of rules may be applied for identifying events, such as the unknown event in a different text file.

In some examples, a subset of a second text file is received for reviewing and identifying events. In some examples, the second text file is related to the text file in operation 502. For instance, both text files may include events related to the same applications, services, or systems. In one instance, the second text file represents a continuation of a data stream forming the text file received in operation 502. In other examples, the second text file is unrelated to the first text file that comprises the subset of text identified in operation 502. The subset of the second text file is compared to the updated set of rules. The comparison may result in the second pattern of characters included in the new rule identifying the unknown event present in the subset of the second text file. Upon identifying the unknown event, it may be categorized as a known event. In some examples, the unknown event may be categorized as a known event upon generating a new rule to identify the unknown event in operation 510. In some examples, the unknown event included in the subset of a text file identifies a software failure. Identifying the software failure may result in identifying a software bug corresponding to the software failure.

In some examples, upon generating the updated set of rules, the unknown event identifiable using the new rule generated in operation 510 is reported to an event handler (e.g., event handler 114 of FIG. 1). An event handler may then create a request to resolve the unknown event. For example, an event handler is a bug filing system used to identify bugs, including information about the unknown event and a request to resolve the error represented as the unknown event. The information may include details (e.g., failure details 340 of FIG. 3) as part of new rule generation in operation 510.

In some examples, generating the updated set of rules comprises identifying the event type of an unknown event in the subset of the text file. The event type information may be mapped to the new rule to store the event type. In some examples, determining the event type results in the performance of an action. For example, determining the type of an unknown event as a software installation error can result in identifying a software bug to resolve the unknown event.

FIG. 6 depicts an example method for identifying a subset of a text file indicative of an event. At operation 602, a text file (e.g., log file 211 of FIG. 2) is received for processing to identify events. The text file may be received over a network (e.g., network 130 of FIG. 1). In some examples, a text file is a pointer to a location within a data stream. In other examples, a text file is at least a portion of a larger text file.

At operation 604, the last operation (e.g., last operation 411 of FIG. 4) in a text file is identified. The last operation is the operation that is recorded in a text file that causes an event after which the text file is not populated. For example, a text file representing a log file for software installation may record the last operation that caused a software failure event or the last operation before a software failure. The last operation may be a function accessed as part of installing software.

At operation 606, a line in the text file associated with the last operation from operation 604 is identified as part of identifying a subset (e.g., log subset 310 of FIG. 3) of a text file. In some examples, the last operation may include an error code (e.g., error code 413 of FIG. 4) used to identify one or more lines in the text file. For example, the error code may be included in a text file populated as part of a software installation/upgrade. As illustrated in FIG. 3, error code “0x800700002” is used to identify that line 311 is to be included in log subset 310. The last operation is the operation that begins but does not complete due to the occurrence of an event. For example, in a software upgrade scenario, a log text file records the last operation before a failure event. As the event occurs during the last operation, the key lines in the text file include information about the event within the subset of log lines that make up the last operation.

Lines associated with the last operation may be identified by evaluating the bottom of the text file and moving upwards through each previous line. The lines are reviewed in this manner to identify the latest set of events recorded in the text file, instead of identifying events at the top of the text file that have been identified in previous iterations of method 600.

At operation 608, lines of text in the text file surrounding the line identified in operation 606 are extracted to identify a subset of text comprising an unknown event. The line identified in operation 606 and the surrounding lines identified in operation 608 are combined to form the subset of the text file. Upon determining the subset of the text file, method 600 may return to operation 504 of method 500 to identify an unknown event in the subset of the text file.

FIG. 7 depicts an example method for processing a subset of a text file before providing the subset of the text file to a language model to identify an unknown event in the subset of the text file. At operation 702, the subset (e.g., log subset 310 of FIG. 3) of a text file (e.g., log file 211 of FIG. 2) is processed by removing information that does not signify the unknown event (e.g., unknown event 221 of FIG. 2). For example, time stamps on every line in a subset of a log file are removed as part of the processing. A processed version of the subset of a text file reduces the number of tokens in the input to a language model (e.g., LLM 230 of FIG. 2), which improves the efficiency of the language model.

At operation 704, key lines (e.g., key lines 320 of FIG. 3) are identified in the subset of the text file processed in operation 702. A language model may be used to determine the key lines to identify an unknown event.

At operation 706, a check is performed to determine whether an additional subset of the text file comprising information about an unknown event is available. If an additional subset of the text is available, method 700 proceeds to operation 708. However, if an additional subset of the text is not available, method 700 proceeds to operation 708.

At operation 708, a key line identified in operation 704 is concatenated to the next subset of the text file identified in operation 706, resulting in a new subset of the text file to identify key lines. Method 700 may return to operation 702 to process the new subset of a text file to identify the key lines.

At operation 710, the key lines of the final subset of the text file are provided to a language model to generate a pattern of characters, such as a regular expression (e.g., regular expression 330 of FIG. 3), based on the key lines. The pattern of characters may uniquely identify the key lines. Upon processing the subset of the text file, method 700 may return to operation 506 of method 500 to provide the subset of the text file to a language model.

FIG. 8 is a block diagram illustrating the physical components (e.g., hardware) of a computing device 800 with which examples of the present disclosure may be practiced. The computing device components described below may be suitable for one or more of the components of the systems described above. In a basic configuration, the computing device 00 includes at least one processing unit 802 and a system memory 804. Depending on the configuration and type of computing device 800, the system memory 804 may comprise volatile storage (e.g., random access memory), non-volatile storage (e.g., read-only memory), flash memory, or any combination of such memories. The system memory 804 may include an operating system 805 and one or more program modules 806 suitable for running software applications 850 (e.g., text analyzer 112 and event handler 114 of FIG. 1) and other applications.

The operating system 805 may be suitable for controlling the operation of the computing device 800. Furthermore, aspects of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 may perform processes including one or more of the stages of methods 500, 600, and 700 illustrated in FIGS. 5-7. Other program modules that may be used in accordance with examples of the present disclosure and may include applications such as search engines and database applications, etc.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to detecting an unstable resource may be operated via application-specific logic integrated with other components of the computing device 800 on the single integrated circuit (chip). Examples of the present disclosure may also be practiced using other technologies capable of performing logical operations such as, for example, AND, OR, and NOT, including mechanical, optical, fluidic, and quantum technologies.

The computing device 800 may also have one or more input device(s) 812 such as a keyboard, a mouse, a pen, a sound input device, a touch input device, a camera, etc. The output device(s) 814 such as a display, speakers, a printer, etc. may also be included. The aforementioned devices are examples and others may be used. The computing device 800 may include one or more communication connections 816 allowing communications with other computing devices 818. Examples of suitable communication connections 816 include RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memory 804, the removable storage device 809, and the non-removable storage device 810 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer readable media may be part of the computing device 800. Computer readable media does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, the technology relates to automated identification of new events. The system includes at least one processor, and memory coupled to the processor, the memory consisting of computer executable instructions that are executed by the system to perform operations. The operation include: identifying a subset of a first text file, the subset of the first text file comprises an unknown event, comparing the subset of the first text file to a set of rules for identifying at least one known event, where the set of rules specifies a first pattern of characters that is indicative of the at least one known event, in response to determining the first pattern of characters does not identify the unknown event, providing the subset of the first text file to a language model, receiving a second pattern of characters from the language model, where the second pattern of characters is indicative of the unknown event, generating a new rule based on the second pattern of characters, where the new rule includes the second pattern of characters and an identifier of the new rule, and generating an updated set of rules by adding the new rule to the set of rules.

In an example, the operations further include: receiving a subset of a second text file, where the subset of the second text file comprises the unknown event, comparing the subset of the second text file to the updated set of rules, and in response to determining the second pattern of characters in the updated set of rules that identifies the unknown event, categorizing the unknown event into a known event.

In an example, identifying a subset of a first text file further includes: receiving the first text file, identifying a last operation at a bottom of the first text file, determining a line in the subset of the first text file associated with the last operation, where the line is identified by starting at the bottom of the first text file and moving backward, and identifying lines surrounding the line forming the subset of the first text file.

In an example, the new rule is generated using the language model. In another example, the language model determines key lines to generate the new rule. In still another example, the operations further include: processing the subset of the first text file, identifying key lines from the subset of the first text file, and concatenating the key lines to a next subset of the first text file associated with a last operation to identify the key lines in the next subset of the first text file.

In an example, providing the subset of the first text file to the language model includes providing a few-shot examples. In another example, the few-shot examples are dynamically selected based on a last operation in the text file.

In an example, providing the subset of the first text file to the language model further includes: processing the subset of the first text file to remove text that is not considered by the first pattern of characters.

In an example, the operations further include: in response to generating the updated set of rules by adding the new rule to the set of rules, reporting the unknown event to an event handler.

In an example, generating the new rule based on the second pattern of characters further includes: determining details associated with the unknown event, where the details are human-readable explanation of the unknown event.

In an example, generating the updated set of rules by adding the new rule to the set of rules further includes: determining an event type for the unknown event identified using the new rule.

In an example, the set of rules are regular expressions matching text in the first text file.

In another aspect, the technology related to a computer-implemented method for performing automated identification of an event. The method includes: identifying a subset of a file, where the subset of the first file comprises an unknown event, comparing the subset of the file to a set of rules for identifying at least one known event, where the set of rules specifies a first pattern of objects that is indicative of at least one known event, in response to determining the first pattern of objects does not identify the unknown event, providing the subset of the first file to an AI model, receiving a second pattern of objects from the AI model, where the second pattern of objects is indicative of the unknown event, generating a new rule based on the second pattern of objects, where the new rule includes the second pattern of objects and an identifier of the new rule, and generating an updated set of rules by adding the new rule to the set of rules.

In an example, a subset of a file is a subset of a text file, first patterns of objects is a first pattern of characters, and second pattern of objects is a second pattern of characters. In another example, identifying a subset of a text file further includes: identifying a last operation at a bottom of the text file, determining a line in the subset of the text file associated with the last operation, where the line is identified by starting at the bottom of the text file and moving backward, and identifying lines surrounding the line forming the subset of the text file. In still another example, providing the subset of the text file to a language model further includes: identifying key lines from the subset of the text file, where the key lines are used to generate the new rule, and concatenating the key lines to a next subset of the text file associated with the last operation to identify the key lines in the next subset of the text file

In still another aspect, the technology relates to automated identification of new events. The system includes at least one processor, and memory coupled to the processor, the memory consisting of computer executable instructions that are executed by the system to perform operations. The operation include: identifying a subset of a text file, where the subset of the text file comprises an unknown event, analyzing a subset of a text file to identify an unknown event using a language model, determining key lines in the subset of the text file using the language model, determining a new rule that identifies the unknown event using the language model, and adding the new rule to a set of rules to generate an updated set of rules.

In an example, analyzing the subset of the text file to identify the unknown event using the language model further includes: comparing the subset of the text file to the set of rules for identifying at least one known event, where the set of rules specifies a first pattern of characters that is indicative of the at least one known event, in response to determining the first pattern of characters does not identify the unknown event, providing the subset of the text file to a language model, and receiving a second pattern of characters from the language model, where the second pattern of characters is indicative of the unknown event.

In another example, determining a new rule that identifies the unknown event using the language model further includes: generating the new rule based on the second pattern of characters, where the new rule includes the second pattern of characters and an identifier of the new rule.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A system comprising:
at least one processor; and
memory coupled to the processor, the memory consisting of computer executable instructions that, when executed by the system, perform operations comprising:
identifying a subset of a first text file, wherein the subset of the first text file comprises an unknown event;
comparing the subset of the first text file to a set of rules for identifying at least one known event, wherein the set of rules specifies a first pattern of characters that is indicative of the at least one known event;
in response to determining the first pattern of characters does not identify the unknown event, providing the subset of the first text file to a language model;
receiving a second pattern of characters from the language model, wherein the second pattern of characters is indicative of the unknown event;
generating a new rule based on the second pattern of characters, wherein the new rule includes the second pattern of characters and an identifier of the new rule; and
generating an updated set of rules by adding the new rule to the set of rules.

2. The system of claim 1, the operations further comprising:
receiving a subset of a second text file, wherein the subset of the second text file comprises the unknown event;
comparing the subset of the second text file to the updated set of rules; and
in response to determining the second pattern of characters in the updated set of rules that identifies the unknown event, categorizing the unknown event into a known event.

3. The system of claim 1, wherein identifying a subset of a first text file further comprises:
receiving the first text file;
identifying a last operation at a bottom of the first text file;
determining a line in the subset of the first text file associated with the last operation, wherein the line is identified by starting at the bottom of the first text file and moving backward; and
identifying lines surrounding the line forming the subset of the first text file.

4. The system of claim 1, wherein the new rule is generated using the language model.

5. The system of claim 4, wherein the language model determines key lines to generate the new rule.

6. The system of claim 5, the operations further comprise:
processing the subset of the first text file;
identifying key lines from the subset of the first text file; and
concatenating the key lines to a next subset of the first text file associated with a last operation to identify the key lines in the next subset of the first text file.

7. The system of claim 1, wherein providing the subset of the first text file to the language model includes providing a few-shot examples.

8. The system of claim 7, wherein the few-shot examples are dynamically selected based on a last operation in the text file.

9. The system of claim 1, wherein providing the subset of the first text file to the language model further comprises:
processing the subset of the first text file to remove text that is not considered by the first pattern of characters.

10. The system of claim 1, the operations further comprise:
in response to generating the updated set of rules by adding the new rule to the set of rules, reporting the unknown event to an event handler.

11. The system of claim 1, generating the new rule based on the second pattern of characters further comprises:
determining details associated with the unknown event, wherein the details are human-readable explanation of the unknown event.

12. The system of claim 1, wherein generating the updated set of rules by adding the new rule to the set of rules further comprises:
determining an event type for the unknown event identified using the new rule.

13. The system of claim 1, wherein the set of rules are regular expressions matching text in the first text file.

14. A computer-implemented method for performing automated identification of an event, the method comprising:
identifying a subset of a file, wherein the subset of the first file comprises an unknown event;
comparing the subset of the file to a set of rules for identifying at least one known event, wherein the set of rules specifies a first pattern of objects that is indicative of at least one known event;
in response to determining the first pattern of objects does not identify the unknown event, providing the subset of the first file to an AI model;
receiving a second pattern of objects from the AI model, wherein the second pattern of objects is indicative of the unknown event;
generating a new rule based on the second pattern of objects, wherein the new rule includes the second pattern of objects and an identifier of the new rule; and
generating an updated set of rules by adding the new rule to the set of rules.

15. The method of claim 14, wherein a subset of a file is a subset of a text file, first patterns of objects is a first pattern of characters, and second pattern of objects is a second pattern of characters.

16. The method of claim 15, wherein identifying a subset of a text file further comprises:
identifying a last operation at a bottom of the text file;
determining a line in the subset of the text file associated with the last operation, wherein the line is identified by starting at the bottom of the text file and moving backward; and
identifying lines surrounding the line forming the subset of the text file.

17. The method of claim 15, wherein providing the subset of the text file to a language model further comprises:
identifying key lines from the subset of the text file, wherein the key lines are used to generate the new rule; and
concatenating the key lines to a next subset of the text file associated with the last operation to identify the key lines in the next subset of the text file.

18. A system comprising:
at least one processor; and
memory coupled to the processor, the memory consisting of computer executable instructions that, when executed by the system, perform operations comprising:
identifying a subset of a text file, wherein the subset of the text file comprises an unknown event;
analyzing a subset of a text file to identify an unknown event using a language model;
determining key lines in the subset of the text file using the language model;
determining a new rule that identifies the unknown event using the language model; and
adding the new rule to a set of rules to generate an updated set of rules.

19. The system of claim 18, wherein analyzing the subset of the text file to identify the unknown event using the language model further comprises:
comparing the subset of the text file to the set of rules for identifying at least one known event, wherein the set of rules specifies a first pattern of characters that is indicative of the at least one known event;
in response to determining the first pattern of characters does not identify the unknown event, providing the subset of the text file to a language model; and
receiving a second pattern of characters from the language model, wherein the second pattern of characters is indicative of the unknown event.

20. The system of claim 19, wherein determining a new rule that identifies the unknown event using the language model further comprises:
generating the new rule based on the second pattern of characters, wherein the new rule includes the second pattern of characters and an identifier of the new rule.
